(19) United States
(12) Patent Application Publication
(10) Pub. No.: US 2003/0053520 A1
(43) Pub. Date: Mar. 20, 2003

(54) Digital telecommunication radio using mutually orthogonal spreading codes to simultaneously transmit multiple data channels within the same ISM transmission band

(75) Inventors: David Paul Nelson, Huntsville, AL (US); Anthony A. Goodloe, Huntsville, AL (US); Michael D. Turner, Huntsville, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Adtran, Inc., Huntsville, AL (US)

(21) Appl. No.: 09/948,361

(22) Filed: Sep. 7, 2001

(51) Int. Cl. H04K 1/00; H04B 15/00; H04L 27/30

(52) U.S. Cl. 375/142; 375/144

(57) ABSTRACT

A spread spectrum communication system for wirelessly transporting autonomously time-referenced telecommunication data couples the data streams to mutually synchronized multiplexers, outputs of which are encoded and applied to associated I and Q channel spreaders, which spread the respective multiplexed data streams using mutually orthogonal spreading code sequences. The resulting spread I-channel data streams are coupled to I and Q channel summing units outputs of which are applied to respective channels of a QPSK modulator and transmitted to a receiver site. At the receiver the QPSK signals are correlated in despreading correlators and then decoded and demultiplexed to produce data streams, corresponding to those applied to the transmitter.

### FIELD OF THE INVENTION

The present invention relates in general to communication systems and is particularly directed to a new and improved digital telecommunication radio that employs mutually orthogonal sets of spread spectrum chip sequences to enable multiple telecommunication data channels (such as T1 data streams) to be simultaneously transmit within the same (ISM) transmission band.

### BACKGROUND OF THE INVENTION

Although legacy (copper) wirelines have served as a principal information transport backbone for a variety of telecommunication networks, the continued development of other types of signal transport technologies, especially those capable of relatively wideband service, including coaxial cable, fiber optic and wireless (e.g., radio) systems, have resulted in a multiplicity of systems that serve a diversity of environments and users, such as ISM (Industrial, Scientific and Medical) customers.

A particular advantage of wireless service is the fact that it is very flexible and not limited to serving only customers having access to existing or readily installable cable plants. Moreover, there are many environments, such as, but not limited to portable data terminal equipments (DTEs), where a digital wireless subsystem may be the only practical means of communication.

To provide digital telecommunication service, the wireless (radio) subsystem is customarily interfaced with an existing digital network's infrastructure, which typically includes legacy wireline links (that may contain one or more repeaters) coupled to an incumbent service provider site. In addition, the digital radio site where access to the wireline is obtained also usually supplies electrical power for operating the radio.

For those environments not offering the required power supply, or which make its cost of its installation prohibitively expensive, there has been developed a digital (T1) radio, described in co-pending U.S. patent application, Ser. No. 09/771,370, filed Jan. 25, 2001, by Eric Rives et al, entitled: “Loop-Powered T1 Radio” (hereinafter referred to as the '370 application), assigned to the assignee of the present application and the disclosure of which is incorporated herein. Because it extracts power from the wireline, the radio described in the '370 application need not be located where a separate dedicated power supply is available or can be readily installed.

Apart from this line-powered feature, the radio employs an ISM-band compatible (e.g., spread spectrum) digital transceiver associated with portable digital terminal equipment, such as a notebook computer, or a remote digital radio that terminates a (powered) wireline. As shown diagrammatically in FIG. 1, the radio includes a transceiver 10 (e.g. one that is ‘blue tooth’-compatible), which performs spread spectrum modulation and up-conversion of baseband signals supplied from a digital data pump (a T1 framer chip) 12 to an FCC-conformal band RF signal (e.g., ISM 2.4—2.4385 GHz or 5.725—5.80 GHz spread spectrum signal), and applied via a first port 21 of a diplexer 20 to an associated radio antenna 25. A second port 22 of the diplexer is coupled to a receiver section of the transceiver, in which the spread RF signal received from the remote site radio is down-converted and demodulated to baseband for application to the data pump 12.

The respective transmit and receive ISM band frequencies interfaced by the diplexer 20 with the antenna 25 are prescribed by one of two complementary frequency plans, the other of which is employed by a companion radio at a remote site. To facilitate selection of either frequency plan, the radio transceiver—diplexer arrangement may be configured in the manner described in the U.S. patent to P. Nelson et al, U.S. Pat. No. 6,178,312, issued Jan. 23, 2001, entitled: “Mechanism for Automatically Tuning Transceiver Frequency Synthesizer to Frequency of Transmit/Receiver Fitler” (hereinafter referred to as the '312 Patent), assigned to the assignee of the present application and the disclosure of which is incorporated herein.

Now although ISM band frequencies are ‘user friendly’, to the extent that they do not require the operator to obtain a license from any regulator agency (e.g. the FCC), still, absent some form of enhanced modulation scheme, the ability to achieve higher data rates in such bands is restricted, which limits the radio's ability to meet continually increasing customer data throughput demands.

### SUMMARY OF THE INVENTION

In accordance with the present invention, this bandwidth usage inefficiency problem is successfully addressed by a new and improved modulation scheme, that employs mutually orthogonal sets of spread spectrum chip sequences to enable multiple telecommunication data streams to be simultaneously transmitted (and recovered) within the same limited (e.g., ISM) transmission band, thereby enabling higher data rates to be transported within existing bandwidth allocations.

In terms of a practical transmitter architecture, a plurality of incoming data streams, such as autonomously time referenced T1 (1.544 MHz) telecommunication data channels, are coupled to mutually synchronized multiplexers that provide elastic buffering. The multiplexers supply combined and mutually synchronized data streams to associated pretransmission encoder units.

Each encoder unit performs conventional scrambling, encoding and forward error correction operations on its received multiplexed data stream and couples its pretransmission processed data stream to each of a pair of identical in-phase (I) channel and quadrature-phase (Q) channel spreading units. The respective I-channel and Q-channel spreading units modulate/spread each of the data values supplied by the encoder units by mutually orthogonal codes sequences of a prescribed number of chips each.

The resulting spread I-channel data streams are coupled to an I-channel summing unit, while the spread Q-channel data streams are coupled to a Q-channel summing unit. The outputs of the I and Q channel summing units are coupled to a QPSK modulator, which provides a QPSK-modulated composite spread signal that is forwarded to downstream stages for transmission over an RF (ISM band) carrier link to a remote receiver site. An interesting property of configuring the transmitter with three mutually orthogonal spreading sequences in cascaded with a QPSK modulator causes the resulting transmitted signal constellation to appear to be that produced by a 16 QAM modulation scheme. However, the original data cannot be recovered through the use of a QAM demodulator; a QPSK demodulator and despreader complementary to that of the transmitter is required.

At the receiver, the received signal is QPSK demodulated into respective composite I and Q spread channels. These channels are applied to sets of I-channel and Q channel despreading correlators, which correlate their received sequences with the respective orthogonal spreading sequences employed by the transmitter. The outputs of the sets of correlators are applied to associated decoder units, which perform forward error correction, and decode and descramble the despread decoded data streams for application as recovered multiplexed (T1) data streams to a set of demultiplexers. Each demultiplexer outputs a plurality (e.g. two) T1 data streams, corresponding to those applied to the transmitter, so as to recover the original data.

### BRIEF DESCRIPTION OF THE DRAWINGS

FIG. 1 diagrammatically illustrates the architecture of a T1 radio of the type described in the above-referenced '370 application;

FIG. 2 is a block diagram of a transmitter architecture utilizing orthogonal sets of spread spectrum chip sequences to simultaneously transport multiple data streams within the same transmission band;

FIG. 3 is a block diagram of a receiver architecture to despread and recover data streams in the combined spread sequence produced by the transmitter of FIG. 2;

FIG. 4 diagrammatically illustrates a non-limiting example of a practical transmitter architecture implementation of the invention;

FIG. 5 shows a constellation resulting from the combined modulation effect of cascading three mutually orthogonal coding sequences with a pair of phase-quadrature channels; and

FIG. 6 diagrammatically illustrates a non-limiting example of a receiver architecture implementation for recovering the data streams transmitted in the QPSK-modulated spread signal transmitted by the transmitter architecture of FIG. 4.

### DETAILED DESCRIPTION

Before describing in detail the new and improved mutually orthogonal spread spectrum-based bandwidth usage enhancement scheme of the present invention, it should be observed that the invention resides primarily in modular arrangements of conventional wireless (radio) transceiver components, digital communication circuits, power supply and connector hardware components. In terms of a practical implementation that facilitates their manufacture and installation at a communication site having access to an existing digital signal transporting wireline cable plant, these modular arrangements may be readily configured using field programmable gate array (FPGA) and application specific integrated circuit (ASIC) chip sets, and commercially available devices and components. As a consequence, the configurations of these arrangements and the manner in which they may be interfaced with an existing digital signal (e.g., T1) wireline link have been illustrated in readily understandable block diagram format, which shows only those specific details that are pertinent to the present invention, so as not to obscure the disclosure with details that are readily apparent to one skilled in the art having the benefit of present description.

Prior to detailing the architecture and operation of the present invention, the properties of mutually orthogonal spreading chip sets, with which a plurality of respective digital data streams (such as but not limited to T1 rate telecommunication data) are spread spectrum modulated and combined for (further QPSK modulation and) transmission will be briefly reviewed in terms of a reduced complexity example, in order to facilitate an appreciation of the manner in which the invention is capable of achieving a relatively high bandwidth efficiency, in contrast to more complex modulation schemes. It is to be understood, however, that the example given here is for purposes of illustration and is not to be considered to be an exhaustive tutorial on the subject. For a further discussion of spread spectrum modulation and the properties of orthogonal chip sequences, attention may be directed to various treatises on communication signal processing.

A fundamental property of two spreading sequences or codes that are mutually orthogonal to each other is that their cross-correlation product is zero. As a consequence, when multiple digital data streams are subjected to or spread by respectively mutually orthogonal spreading codes, it is possible for all of the spread data streams to be transmitted simultaneously over the same communication channel and be successfully recovered at the receiver. A non-limiting example of orthogonal codes that may be used for this purpose are Hadamard-Walsh codes, which may be easily constructed in lengths of powers of two. It is to be understood, however, that other types of orthogonal codes may be employed as equivalents. Hadamard-Walsh codes are given here for purposes of providing an illustrative, non-limiting example.

Consider the following set of recursive relationships:

$${H}_{n} = \vert \begin{matrix}{H}_{n / 2} & {H}_{n / 2} \\ {H}_{n / 2} & - {H}_{n / 2}\end{matrix} \vert$$

$$w i t h {H}_{2} = \vert \begin{matrix}1 & 1 \\ 1 & - 1\end{matrix} \vert ,$$

powers-of-two Hadamard-Walsh codes can be readily constructed.

As an example, consider the following 4×4 Hadamard-Walsh matrix:

$${H}_{4} = \vert \begin{matrix}1 & 1 & 1 & 1 \\ 1 & - 1 & 1 & - 1 \\ 1 & 1 & - 1 & - 1 \\ 1 & - 1 & - 1 & 1 \end{matrix} \vert .$$

From this matrix, the values listed in its second, third and fourth columns can be used to derive the following three non-trivial Hadamard-Walsh codes or sequences as:

A=[1, −1, 1, −1],

B=[1, 1, −1, −1] and

C=[1, −1, −1, 1].

A comparison of each of the code sequences A, B and C reveals that each is mutually orthogonal to the other two.

For example,

A×B=(1×1)+(−1×1)+(1×−1)+(−1×−1)=0.

The same result (0) is obtained for A×C and B×C.

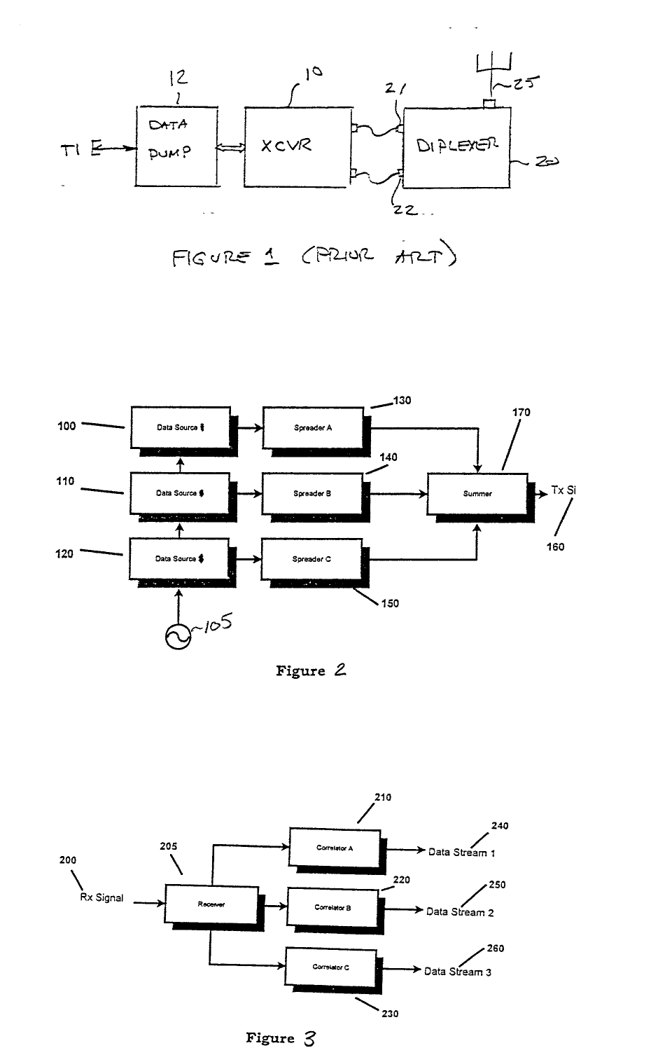

As illustrated in the transmitter block diagram FIG. 2, this mutual orthogonality property is exploited by the present invention to configure a transmission scheme that enables the usage of a given bandwidth to be substantially increased in accordance with the number orthogonal spreading codes employed, each orthogonal spreading code being used to spread a respectively different digital data stream. In the transmitter diagram of FIG. 2, three respective data sources 100, 110 and 120 (which are mutually synchronized by a common clock 105) supply serialized digital data streams to associated spreaders 130, 140 and 150. These spreaders are operative to modulate/spread the data values supplied by the respective data sources 100, 110 and 120 by the three respective codes sequences A, B and C set forth above.

For purposes of illustration, let the respective data sources 100, 110 and 120 generate the binary data values +1, −1, −1. In this example a +1 corresponds to a first binary value, and a −1 corresponds to a second binary value. Other binary values (such as 0 and 1 could also be used) without a loss of generality. Using the mutually orthogonal spreading codes set forth above, these three data values (i.e. +1, −1, −1) will be spread over a four chip length in respective spreaders 130, 140 and 150 as the chips: [1,−1,1,−1]; [1,1,−1,−1]; and [1,−1,−1,1]. When these chip sequences are combined by means of a spread output combiner or ‘summer’ 170, the resultant total T=A−B−C at the output 160 of the summer 170 will be the following sequence of values:

$$\begin{matrix}T = [ 1 , - 1 , 1 , - 1 ] - [ 1 , 1 , - 1 , - 1 ] - [ 1 , - 1 , - 1 , 1 ] \\ = [ - 1 , - 1 , 3 , - 1 ] .\end{matrix}$$

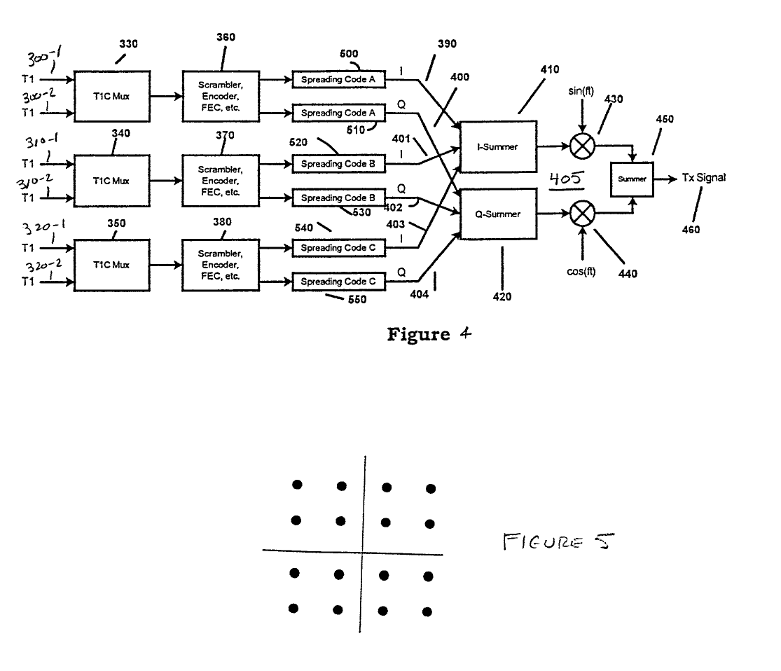

FIG. 3 is a block diagram of a receiver architecture to which this combined sequence T is transported over a communication channel. In the receiver, the signal 200 (combined spread and whatever additional modulation may have been imparted at the transmitter) as received by a receiver 205 is applied as the signal sequence R to each of a set of correlators 210, 220 and 230. Each correlator is operative to correlate the received sequence R over one data symbol time (four chips in the present example), by multiplying each received chip by a respective one of the orthogonal sequences A, B and C associated with that correlator.

In the present example, correlator 210 correlates the received chip with orthogonal code sequence A and provides an output data stream 240. Namely, correlator 210 performs the following operation:

R×A=[−1,−1,3,−1]×[1,−1,1,−1]^{T}=4.

Likewise, correlator 220 correlates the received sequence R with orthogonal code sequence B and provides an output data stream 250; correlator 230 correlates the received chip with orthogonal code sequence C and provides an output data stream 260. The correlation operations performed by correlators 220 and 230 will produce the values −4 and −4.

In the present example, a positive polarity of the correlation value represents a binary data value of +1, while a negative polarity of the correlation value represents a binary data value of −1. Namely, the output of a respective correlator is equal to plus or minus the data value equal to the number of chips over which the accumulation takes place. This means that the received chip sequence [−1,−1,3,−1] produces the data values +1, −1, −1, corresponding to those originally supplied by the respective data sources 100, 110 and 120.

In the foregoing example, each of the data sources 100, 110 and 120 at the transmit site is referenced to a common clock 105. In terms of a practical application of the invention to a real world communication environment, incoming data will be supplied by respective autonomous communication channels (such as a plurality of T1 (1.544 MHz) channels) that are not necessarily and can reasonably be expected to be independent of one another. It is therefore necessary to provide a mechanism for mutually synchronizing the respective data streams.

FIG. 4 diagrammatically illustrates a non-limiting example of a practical transmitter architecture implementation that not only synchronizes the data streams, but provides for an additional degree of bandwidth usage efficiency. Data stream synchronization is accomplished by employing respective mutually synchronized multiplexers to interface multiple data streams to the spreaders; quadrature modulation (in particular, quadrature phase shift keying (QPSK) modulation) of the combined spread data streams is used to improve bandwidth usage efficiency.

More particularly, in the transmitter architecture of FIG. 4, a set of three multiplexers 330, 340 and 350 (which include elastic buffering and conform with ANSI T1.107) are coupled to received three pairs of T1 digital data streams 300-1, 300-2; 310-1, 310-2; and 320-1, 320-2. It should be noted that the invention is not limited to the use of this (three in the present example) or any particular number of multiplexers, or number of input data streams supplied to each multiplexer (two data streams per multiplexer in the present example). The numbers employed in the present example are for the purposes of providing a practical example in the context of the parameters of the data channels (T1) and the ISM bands of interest.

The three multiplexers 330, 340 and 340 produce combined (interleaved) and mutually synchronized T1 data streams to associated transmitter encoder units 360, 370 and 380, respectively. Each encoder unit is operative to perform conventional pretransmission operations, including data scrambling (differential) encoding and forward error correction operations on its received T1 data stream. The resulting pretransmission processed data stream is coupled to each of a pair of identical in-phase (I) channel and quadrature-phase (Q) channel spreading units.

In particular, the encoded outputs of encoder unit 360 are coupled to an I-channel spreading unit 500 and a Q-channel spreading unit 510; the encoded outputs of encoder unit 370 are coupled to an I-channel spreading unit 520 and a Q-channel spreading unit 530; and the encoded outputs of encoder unit 380 are coupled to an I-channel spreading unit 540 and a Q-channel spreading unit 550.

Similar to the transmitter architecture of FIG. 2, the respective I-channel spreading units 500, 520 and 540 and also the respective Q-channel spreading units 510, 530 and 550 are operative to modulate/spread each of the data values supplied by the encoder units 360, 370 and 380 by three mutually orthogonal codes sequences of a prescribed number of chips (again designated as spreading codes A, B and C). The resulting spread I-channel data streams are coupled over links 390, 401 and 403 to an I-channel summing unit 410, while the spread Q-channel data streams are coupled over links 400, 402 and 404 to a Q-channel summing unit 420.

The outputs of these two summing units are applied to a QPSK modulator 405. In particular, the output of the I-channel summing unit 410 is coupled to an I-channel mixer 430, wherein the composite I-channel spread signal is multiplied by a prescribed modulation frequency and applied to a first input of a QPSK a summer 450. The output of the Q-channel summing unit 420 is coupled to a Q-channel mixer 440, wherein the composite I-channel spread signal is multiplied by the modulation frequency (in quadrature phase relative to the frequency applied to mixer 430) and applied to a second input of the QPSK summer 450. The resultant QPSK-modulated composite spread signal (Tx Signal) 460 produced by summer 450 is forwarded to downstream stages for transmission over an RF (ISM band) carrier link to a remote receiver site.

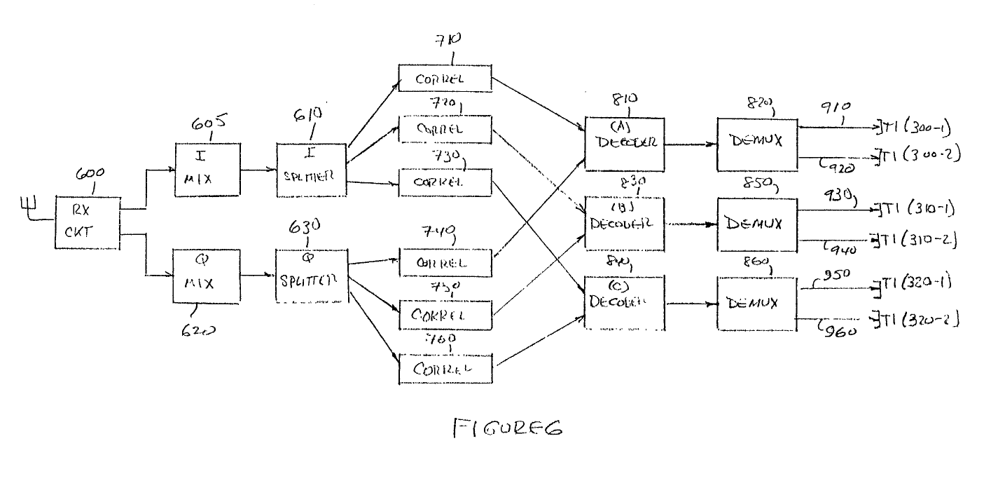

FIG. 5 is a graphic plot of the signal constellation resulting from the combined modulation effect of cascading three mutually orthogonal coding sequences with a pair of phase-quadrature channels as in the transmitter example of FIG. 4. As pointed out previously, while this signal constellation appears to be that produced by a 16 QAM modulation scheme, attempting to recover the original data through the use of a QAM demodulator would be unsuccessful. A QPSK demodulator and despreader complementary to that of the transmitter (to be described below with reference to FIG. 6) are required.

FIG. 6 diagrammatically illustrates a non-limiting example of a receiver architecture implementation for recovering the data streams transmitted in the QPSK-modulated spread signal transmitted by the transmitter of FIG. 4. Downstream of front end RF receiver circuitry 600, the received QPSK signal is coupled to a QPSK demodulator. This includes an I-channel mixer 605, wherein the QPSK-modulated composite spread signal is multiplied by the QPSK modulation frequency and applied to an I channel signal splitter 610. Similarly, the QPSK output is coupled to a Q-channel mixer 620, wherein the QPSK-modulated composite spread signal is multiplied by the QPSK modulation frequency (in quadrature phase relative to the frequency applied to the I-channel mixer 605) and applied to I-channel splitter 630.

The resultant QPSK-demodulated I-channel composite signals are applied to each of set of I-channel despreading correlators 710, 720 and 730. The resultant QPSK-demodulated Q-channel composite signals are applied to each of set of Q-channel despreading correlators 740, 750 and 760. Similar to the receiver architecture of FIG. 3, the respective I-channel correlators 710, 720, 730 and also the respective Q-channel correlators 740, 750 and 760 are operative to correlate their respective received sequences with a respective one of the orthogonal spreading sequences (A, B and C) associated with that correlator. In the present example, the correlators 710 and 740 correlate their respective I and Q channel signals with orthogonal code sequence A; correlators 720 and 750 correlate their respective I and Q channel signals with orthogonal code sequence B; and correlators 730 and 760 correlate their respective I and Q channel signals with orthogonal code sequence C.

The outputs of the I-channel correlator 710 and the Q-channel correlator 720 are applied to an A-chip decoder unit 810, which performs forward error correction, and decodes and descrambles the despread decoded data stream for application as a recovered multiplexed (T1) data stream to a demultiplexer 820. Demultiplexer 820 then demultiplexes the two T1 data streams for application to T1 output links 910 and 920. In like manner, the outputs of I-channel correlators 730, 750 and Q-channel correlators 720, 740 are applied to respective B and C-chip decoder units 830, 840, whose outputs are coupled to demultiplexers 850, 860. Demultiplexer 850 demultiplexes the two T1 data streams from decoder unit 830 for application to T1 output links 930 and 940; and demultiplexer 860 demultiplexes the two T1 data streams from decoder unit 840 for application to T1 output links 950 and 960.

As these three pairs of digital data streams correspond to the original (T1) digital data streams 300-1, 300-2; 310-1, 310-2; and 320-1, 320-2 that were coupled to the transmitter of FIG. 4, described above, the digital radio at the receiver site has successfully recovered a plurality digital telecommunication data streams within the limitations of the ISM band.

As will be appreciated from the foregoing description, the bandwidth usage inefficiency problem of conventional spread spectrum digital radio implementations is successfully addressed by the composite modulation scheme of the present invention, which employs mutually orthogonal sets of spread spectrum chip sequences to simultaneously transport multiple telecommunication data streams within the same limited (e.g., ISM) transmission band, thereby enabling higher data rates within existing bandwidth allocations.

While we have shown and described several embodiments in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed is:

1. A communication architecture comprising:
a plurality of signal spreaders which are adapted to spread respective input data streams coupled thereto in accordance with mutually orthogonal spreading sequences, and thereby produce a plurality of spread data streams; and
a output unit which is adapted to combine said plurality of spread data streams into a composite spread output data stream for transmission over a communication channel.

2. The communication architecture according to claim 1, further including a plurality of multiplexers, each of which is coupled to receive a plurality of digital data streams and is adapted to multiplex said plurality of digital data streams into a respective one of said input data streams for application to a respective one of said plurality of signal spreaders.

3. The communication architecture according to claim 1, further including an RF transmitter coupled to said output unit and being adapted to transmit said composite spread output data stream over an RF communication channel.

4. The communication architecture according to claim 3, wherein said input data streams comprise time division multiplexed telecommunication digital data streams, and wherein said RF transmitter is operative to transmit said composite spread output data stream over an ISM band-compliant RF communication channel.

5. The communication architecture according to claim 3, wherein said RF transmitter is adapted to modulate said composite spread output data stream in respective phase offset channels, so as to produce phase offset modulation output signals, and to combine said phase offset modulation output signals into a composite output signal for transmission over said communication channel.

6. The communication architecture according to claim 3, wherein said RF transmitter is adapted to transmit said composite spread output data stream in accordance with quadrature phase shift keying (QPSK) modulation.

7. The communication architecture according to claim 3, further including an RF receiver coupled to receive said composite spread output data stream that has been transmitted over said RF communication channel, and a plurality of signal despreaders, which are adapted to despread said received composite spread output data stream into respective output data streams, in accordance with respective ones of said mutually orthogonal spreading sequences.

8. The communication architecture according to claim 7, further including:
a plurality of multiplexers, each of which is coupled to receive a plurality of digital data streams and is adapted to combine said plurality of digital data streams into a respective one of said input data streams for application to a respective one of said plurality of signal spreaders; and
a plurality of demultiplexers, each of which is coupled to demultiplex a respective one of said output data streams into a plurality of digital data streams.

9. A method of transmitting information contained in a plurality of input data streams comprising the steps of:
(a) spreading said input data streams in accordance with mutually orthogonal spreading sequences, so as to produce a plurality of spread data streams; and
(b) combining said plurality of spread data streams into a composite spread output data stream for transmission over a communication channel.

10. The method according to claim 9, wherein step (a) includes the preliminary step of multiplexing a plurality of digital data streams into a respective one of said input data streams.

11. The method according to claim 9, further including the step (c) of transmitting said composite spread output data stream over an RF communication channel.

12. The method according to claim 11, wherein step (c) comprises modulating said composite spread output data stream in respective phase offset channels, so as to produce phase offset modulation output signals, and combining said phase offset modulation output signals into a composite output signal for transmission over said communication channel.

13. The method according to claim 11, wherein step (c) comprises transmitting said composite spread output data stream in accordance with quadrature phase shift keying (QPSK) modulation.

14. The method according to claim 11, further including the steps of:
(d) receiving said composite spread output data stream that has been transmitted over said RF communication channel; and
(e) despreading said received composite spread output data stream into respective output data streams, in accordance with respective ones of said mutually orthogonal spreading sequences.

15. The method according to claim 14, wherein step (a) includes the preliminary step of multiplexing a plurality of digital data streams into a respective one of said input data streams, and further including the step (f) of demultiplexing a respective one of said output data streams into a plurality of digital data streams.

16. The method according to claim 11, wherein said input data streams comprise time division multiplexed telecommunication digital data streams, and wherein step (c) comprises transmitting said composite spread output data stream over an ISM band-compliant RF communication channel.

17. An apparatus for demodulating a communication signal that has been received from a communication channel and contains a waveform comprised of a composite of a plurality of spread data streams respective ones of which have been spread in accordance with respective, mutually orthogonal spreading sequences, said apparatus comprising:
a plurality of signal despreaders, adapted to despread said composite of said plurality of spread data streams into respective output data streams, in accordance with respective ones of said mutually orthogonal spreading sequences; and
output interface circuits coupled to said signal despreaders and being adapted to output said respective output data streams despread by said plurality of signal despreaders.

18. The apparatus according to claim 17, wherein said output interface circuits include demultiplexers, each of which is coupled to demultiplex a respective one of said output data streams into a plurality of digital data streams.

19. The apparatus according to claim 17, wherein said waveform contains QPSK modulation of said composite of said plurality of spread data streams, and wherein said apparatus further includes a QPSK demodulator that is adapted to demodulate said waveform into respective I and Q channel composite spread data streams, and wherein said plurality of signal despreaders include I and Q channel associated despreaders.

20. The apparatus according to claim 17, wherein said data streams comprise time division multiplexed telecommunication digital data streams, and wherein said communication channel comprises an ISM band-compliant RF communication channel.
